(19) United States
(12) Patent Application Publication
(10) Pub. No.: US 2013/0082577 A1
(43) Pub. Date: Apr. 4, 2013

(54) ADHESIVE RESIN COMPOSITION FOR HDD MOTOR AND HDD MOTOR FABRICATED BY USING THE SAME

(71) Applicants: Kun KIM, Suwon (KR); Hyung Kyu Kim, Daejeon (KR)

(72) Inventors: Kun KIM, Suwon (KR); Hyung Kyu Kim, Daejeon (KR)

(73) Assignee: SAMSUNG ELECTRO-MECHANICS CO., LTD.

(21) Appl. No.: 13/333,165

(22) Filed: Dec. 21, 2011

(30) Foreign Application Priority Data
Sep. 30, 2011 (KR) 10-2011-0099653

(51) Int. Cl. C09J 4/02; C09J 11/04; H02K 5/167; C09J 11/06

(52) U.S. Cl. 310/425; 522/96; 522/79; 522/81

(57) ABSTRACT

There are provided an adhesive resin composition for a hard disk drive (HDD) motor and a HDD motor fabricated by the using the same. The adhesive resin composition includes: 45 to 55 parts by weight of an urethane methacrylate oligomer, 35 to 45 parts by weight of hydroxylalkyl methacrylate, 1 to 3 parts by weight of an acrylic acid, 1 to 2 parts by weight of organic hydroperoxide, and 2 to 5 parts by weight of a photo initiator. The HDD motor may be fabricated using the adhesive resin composition for a HDD motor prepared by controlling contents of an UV curable adhesive and a primer to reduce generation of outgas, whereby improved reliable quality of the motor may be obtained.

### CROSS-REFERENCE TO RELATED APPLICATIONS

This application claims the priority of Korean Patent Application No. 10-2011-0099653 filed on Sep. 30, 2011, in the Korean Intellectual Property Office, the disclosure of which is incorporated herein by reference.

### BACKGROUND OF THE INVENTION

1. Field of the Invention

The present invention relates to an adhesive resin composition for a hard disk drive (HDD) motor capable of securing reliable quality by preventing a generation of outgas, and a HDD motor fabricated by the using the same.

2. Description of the Related Art

A hard disk drive (HDD), an information storage device, reads data stored on a disk or writes data to the disk using a read/write head.

The hard disk drive requires a disk driving device capable of driving the disk. In the disk driving device, a small-sized spindle motor is used.

This small-sized spindle motor has used a fluid dynamic bearing assembly. Lubricating fluid is interposed between shaft, a rotating member of the fluid dynamic bearing assembly, and a sleeve, a fixed member thereof, such that the shaft is supported by fluid pressure generated in the lubricating fluid.

In fabricating the fluid dynamic bearing assembly, an ultraviolet (UV) curable adhesive and a primer have been used at the time of adhesion between the sleeve and a base member, both of which are fixed members.

However, the adhesion process using the UV curable adhesive and the primer may generate outgas, thereby causing difficulty in securing reliable quality.

In addition, a high temperature process for curing may be performed for a long period of time, thereby causing deterioration workability efficiency.

Therefore, customer demand for securing reliable quality of a HDD motor has increased. Particularly, due to an outgas defect in a motor assembled with an adhesive, complementary material, an error may occur in a storage function of the HDD. Therefore, a pre-test for securing reliable quality by quantitatively standardizing outgas of an adhesive material has necessarily been emphasized before the mass-production of products.

### SUMMARY OF THE INVENTION

An aspect of the present invention provides an adhesive resin composition for a hard disk drive (HDD) motor capable of securing reliable quality therein, by preventing the generation of outgas, and a HDD motor fabricated by the same.

According to an aspect of the present invention, there is provided an adhesive resin composition for a hard disk drive (HDD) motor, the adhesive resin composition including 45 to 55 parts by weight of an urethane methacrylate oligomer, 35 to 45 parts by weight of hydroxylalkyl methacrylate, 1 to 3 parts by weight of an acrylic acid, 1 to 2 parts by weight of organic hydroperoxide, and 2 to 5 parts by weight of a photo initiator.

The adhesive resin composition may further include 1 to 5 parts by weight of primer.

The primer may include 95 parts by weight or more of acetone and 0.5 to 3 parts by weight of copper soap.

The primer may include 1 to 3 parts by weight of the copper soap.

The adhesive resin composition may include 3 to 5 parts by weight of the photo initiator.

According to another aspect of the present invention, there is provided a HDD motor including an adhesive resin composition including 45 to 55 parts by weight of an urethane methacrylate oligomer, 35 to 45 parts by weight of hydroxylalkyl methacrylate, 1 to 3 parts by weight of an acrylic acid, 1 to 2 parts by weight of organic hydroperoxide, and 2 to 5 parts by weight of a photo initiator.

The adhesive resin composition may further include 1 to 5 parts by weight of primer.

The primer may include 95 parts by weight or more of acetone and 0.5 to 3 parts by weight of copper soap.

The primer may include 1 to 3 parts by weight of the copper soap.

The adhesive resin composition may include 3 to 5 parts by weight of the photo initiator.

The adhesive resin composition may adhere a base member and a sleeve of the HDD motor to each other.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a portion to which an adhesive resin composition for a hard disk drive (HDD) motor according to an embodiment of the present invention is applied; and

FIG. 2 is a schematic cross-sectional view showing a HDD motor including the adhesive resin composition for a HDD motor according to the embodiment of the present invention.

### DETAILED DESCRIPTION OF THE INVENTION

Embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

Embodiments of the present invention will now be described in detail with reference to the accompanying drawings.

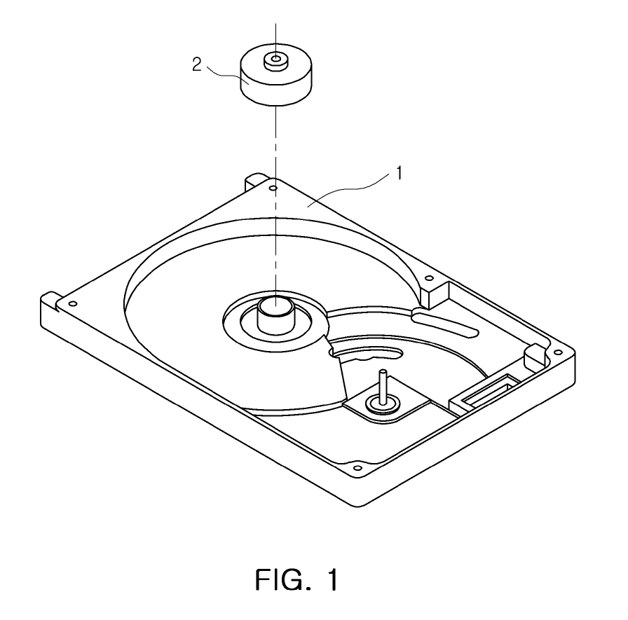

FIG. 1 is a schematic perspective view showing a portion to which an adhesive resin composition for a hard disk drive (HDD) motor according to an embodiment of the present invention is applied.

Referring to FIG. 1, the adhesive resin composition for a HDD motor according to the embodiment of the present invention may include 45 to 55 parts by weight of urethane methacrylate oligomer, 35 to 45 parts by weight of hydroxylalkyl methacrylate, 1 to 3 parts by weight of acrylic acid, 1 to 2 parts by weight of organic hydroperoxide, and 2 to 5 parts by weight of photo initiator.

Hereinafter, the above configuration will be described in detail.

The adhesive resin composition for a HDD motor according to the embodiment of the present invention may include 45 to 55 parts by weight of urethane methacrylate oligomer.

The urethane methacrylate oligomer may serve to have an influence on a physical property of a coating of the curable adhesive resin composition at the time of adhesion between an inner portion of a base member 1 of the HDD motor to be described below and a surface of a sleeve 2.

A content of the urethane methacrylate oligomer may be 45 to 55 parts by weight based on 100 parts by weight of adhesive resin composition for a HDD motor. When the content of the urethane methacrylate oligomer is less than 45 parts by weight, adhesion may be reduced, and when the content of the urethane methacrylate oligomer exceeds 55 parts by weight, the physical property of the coating of the curable adhesive resin composition may be deteriorated.

In addition, the adhesive resin composition for a HDD motor may include 35 to 45 parts by weight of hydroxylalkyl methacrylate.

The hydroxylalkyl methacrylate may serve to have an influence on the physical property of the coating of the curable adhesive resin composition.

A content of the hydroxylalkyl methacrylate be 35 to 45 parts by weight based on 100 parts by weight of adhesive resin composition for a HDD motor. When the content of the hydroxylalkyl methacrylate is less than 35 parts by weight and when the content of the hydroxylalkyl methacrylate exceeds 45 parts by weight, the physical property of the coating of the curable adhesive resin composition may be deteriorated.

The adhesive resin composition for a HDD motor according to the embodiment of the present invention may include 1 to 3 parts by weight of acrylic acid.

The acrylic acid may serve to control viscosity and workability of the adhesive resin composition for a HDD motor and impart functionality to the composition.

A content of the acrylic acid may be 1 to 3 parts by weight based on 100 parts by weight of adhesive resin composition for a HDD motor. When the content of the acrylic acid is less than 1 part by weight, it may be difficult to control the viscosity and the workability of the adhesive resin composition and the effect of adding the acrylic acid may be relatively small, and when the content of the acrylic acid exceeds 3 parts by weight, the physical property of the adhesive resin composition may be deteriorated due to addition of an excessive amount.

The adhesive resin composition for a HDD motor according to the embodiment of the present invention may include 1 to 2 parts by weight of organic hydroperoxide.

The organic hydroperoxide may serve to improve adhesion of the adhesive resin composition for a HDD motor and impart functionality to the composition.

A content of the organic hydroperoxide may be 1 to 2 parts by weight based on 100 parts by weight of adhesive resin composition for a HDD motor. When the content of the organic hydroperoxide is less than 1 part by weight, the effect of improving the adhesion of the adhesive resin composition may be relatively small, and when the content of the organic hydroperoxide exceeds 2 parts by weight, the physical property of the adhesive resin composition may be deteriorated due to addition of an excessive amount.

In addition, the adhesive resin composition for a HDD motor according to the embodiment of the present invention may include 2 to 5 parts by weight of photo initiator, particularly, 3 to 5 parts by weight of photo initiator.

The photo initiator may serve decompose and activate the adhesive resin composition by ultraviolet (UV) irradiation to generate polymerization, thereby curing the adhesive resin composition.

According to the embodiment of the present invention, 2 to 5 parts by weight of photo initiator, particularly, 3 to 5 parts by weight of photo initiator may be contained in the adhesive resin composition for a HDD motor to reduce generation of outgas, whereby improved reliable quality of the motor may be obtained.

In addition, a heat-curing time of the adhesive resin composition may be reduced, whereby the workability may be improved.

A content of the photo initiator may be 2 to 5 parts by weight based on 100 parts by weight of adhesive resin composition for a HDD motor. When the content of the photo initiator is less than 2 parts by weight, the outgas may be generated, and when the content of the photo initiator exceeds 5 parts by weight, an excessive amount of photo initiator may have an influence on the physical property of the adhesive resin composition.

The adhesive resin composition for a HDD motor according to the embodiment of the present invention may further include 1 to 5 parts by weight of primer.

The primer may be used for pre-treating the adhesive resin composition and serve to promote a curing speed after the adhesive resin composition pre-treated using the primer is applied to a surface.

The primer may include 95 parts by weight or more of acetone. However, a content of the acetone is not particularly limited.

In addition, the primer may include 0.5 to 3 parts by weight of copper soap, particularly, 1 to 3 parts by weight of copper soap.

According to the embodiment of the present invention, the primer contains 0.5 to 3 parts by weight of copper soap to reduce the generation of the outgas, whereby the improved reliable quality of the motor may be obtained.

In addition, the copper soap may promote a curing speed of the adhesive resin composition, whereby a heating-curing time of the adhesive resin composition may be reduced.

When a content of the copper soap contained in the primer is less than 0.5 parts by weight, the heating-curing time of the adhesive resin composition may not be reduced.

In addition, when the content of the copper soap contained in the primer exceeds 3 parts by weight, it may have a negative influence on the physical property of the adhesive resin composition.

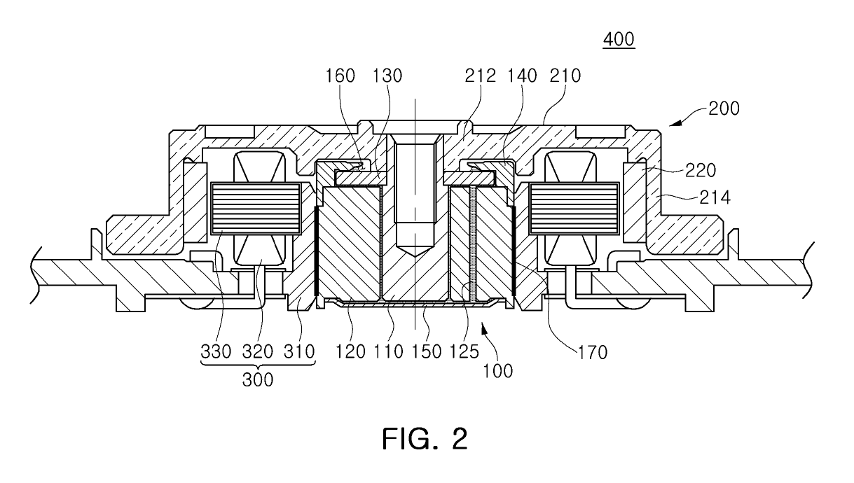

FIG. 2 is a schematic cross-sectional view showing a HDD motor including the adhesive resin composition for a HDD motor according to the embodiment of the present invention.

Referring to FIG. 2, the HDD motor 400 according to another embodiment of the present invention may include an adhesive resin composition 170 containing 45 to 55 parts by weight of urethane methacrylate oligomer, 35 to 45 parts by weight of hydroxylalkyl methacrylate, 1 to 3 parts by weight of acrylic acid, 1 to 2 parts by weight of organic hydroperoxide, and 2 to 5 parts by weight of photo initiator.

The adhesive resin composition 170 may further include 1 to 5 parts by weight of primer.

The primer may include 95 parts by weight or more of acetone and 0.5 to 3 parts by weight of copper soap, particularly, 1 to 3 parts by weight of copper soap.

The adhesive resin composition may include 3 to 5 parts by weight of photo initiator.

Hereinafter, the HDD motor according to another embodiment of the present invention will be described in detail. However, a portion overlapped with the description in the above-mentioned embodiment of the present invention will be omitted.

The HDD motor 400 may include an oil sealing part 160 formed between fixed members 120 and 140 and rotating members 110, 130, and 212, particularly, between a sleeve 120, a thrust plate 130, and a cap 140.

The cap 140 may be a member that is press-fitted onto an upper portion of the thrust plate 130 to thereby allow lubricating fluid to be sealed between the cap 140 and the thrust plate 130, and include a circumferential groove formed in an circumferential surface thereof so as to be press-fitted into the thrust plate 130 and the sleeve 120.

The cap 140 may include a protrusion part formed on a lower surface thereof in order to seal the lubricating fluid, which uses a capillary phenomenon and a surface tension of the lubricating fluid in order to prevent the lubricating fluid from being leaked to the outside at the time of driving of the motor.

Meanwhile, an HDD motor 400 according to another embodiment of the present invention may include a shaft 110, the sleeve 120, the thrust plate 130, the cap 140, and the oil sealing part 160.

The sleeve 120 may support the shaft 110 so that an upper end of the shaft 110 protrudes upwardly in an axial direction, and may be formed by forging copper (Cu) or aluminum (Al) or sintering copper-iron (Cu—Fe) based alloy powders or SUS based powders.

Here, the shaft 110 may be inserted into a shaft hole of the sleeve 120 so as to have a micro clearance therewith. The micro clearance may be filled with the lubricating fluid, and the rotation of a rotor 200 may be more smoothly supported by a radial dynamic groove formed in at least one of an outer circumferential surface of the shaft 110 and an inner circumferential surface of the sleeve 120.

The radial dynamic groove may be formed in an inner side of the sleeve 120, which is an inner portion of the shaft hole of the sleeve 120, and may generate pressure so as to be deflected toward one side at the time of rotation of the shaft 110.

However, the radial dynamic groove is not limited to being formed in the inner side of the sleeve 120 as described above but may also be formed in an outer circumferential surface portion of the shaft 110. In addition, the number of radial dynamic grooves is not limited.

The sleeve 120 may include a bypass channel 125 formed therein in order to allow upper and lower portions thereof to be communication with each other to disperse pressure of the lubricating fluid in an inner portion of a fluid dynamic bearing assembly 100, thereby maintaining balance in the pressure, and may move air bubbles, or the like, present in the inner portion of the fluid dynamic bearing assembly 100 so as to be discharged by circulation.

Here, the sleeve 120 may include a cover plate 150 coupled to a lower portion thereof, having a clearance therebetween, wherein the clearance receives the lubricating fluid therein.

The cover plate 150 may receive the lubricating fluid in the clearance between the cover plate 150 and the sleeve 120 to thereby serve as a bearing supporting a lower surface of the shaft 110.

The thrust plate 130 may be disposed on an upper portion of the sleeve 120 in the axial direction and include a hole formed at the center thereof, wherein the hole is formed to correspond to a cross section of the shaft 110. The shaft 110 may be inserted into this hole.

Here, the thrust plate 130 may be separately fabricated and then coupled to the shaft 110. However, the thrust plate 130 may be formed integrally with the shaft 110 at the time of fabricating thereof and may rotate together with the shaft 110 at the time of the rotation of the shaft 110.

In addition, the thrust plate 130 may include a thrust dynamic groove formed in an upper surface thereof, wherein the thrust dynamic groove provides thrust dynamic pressure to the shaft 110.

The thrust dynamic groove is not limited to being formed in the upper surface of the thrust plate 130 as described above but may also be formed in an upper surface of the sleeve 120 corresponding to a lower surface of the thrust plate 130.

The stator 300 may include a winding coil 320, a core 330, and a base member 310.

In other words, the stator 300 may be a fixed structure including the winding coil 320 generating electromagnetic force having a predetermined magnitude at the time of application of power and a plurality of cores 330 having the winding coil 320 wound therearound.

The core 330 may be fixedly disposed on an upper portion of the base member 310 including a printed circuit board (not shown) having pattern circuits printed thereon, a plurality of coil holes having a predetermined size may be formed to penetrate through the base member 310 so as to expose the winding coil 320 downwardly, penetrating a portion of the base member 310 corresponding to the winding coil 320, and the winding coil 320 may be electrically connected to the printed circuit board (not shown) so that external power is supplied thereto.

An outer peripheral surface of the sleeve 120 may be press-fitted into the base member 310 to thereby be fixed thereto, and the core 330 having the winding coil 320 wound therearound may be inserted into the base member 310. In addition, the base member 310 and the sleeve 120 may be assembled with each other by applying an adhesive to an inner surface of the base member 310 or an outer surface of the sleeve 120.

The adhesive resin composition 170 applied to the inner surface of the base member 310 or the outer surface of the sleeve 120 to adhere the base member 310 and the sleeve 120 to each other may include 45 to 55 parts by weight of urethane methacrylate oligomer, 35 to 45 parts by weight of hydroxylalkyl methacrylate, 1 to 3 parts by weight of acrylic acid, 1 to 2 parts by weight of organic hydroperoxide, and 2 to 5 parts by weight of photo initiator.

In addition, the adhesive resin composition 170 may further include 1 to 5 parts by weight of primer.

The primer may include 95 parts by weight or more of acetone and 0.5 to 3 parts by weight of copper soap, particularly, 1 to 3 parts by weight of copper soap.

As described above, according to the embodiment of the present invention, the adhesive resin composition 170 contains 2 to 5 parts by weight of photo initiator and the primer containing 95 parts by weight or more of acetone and 0.5 to 3 parts by weight of copper soap to reduce the generation of the outgas, whereby the improved reliable quality of the motor may be obtained.

In addition, a heat-curing time of the adhesive may be reduced, whereby the workability may be improved.

The rotor 200, which is a rotational structure rotatably provided with respect to the stator 300, may include a rotor case 210 having an annular ring shaped magnet 220 provided on an outer peripheral surface thereof, wherein the annular ring shaped magnet 220 corresponds to the core 330, having a predetermined interval therebetween.

Here, as the magnet 220, a permanent magnet generating magnetic force having predetermined strength by alternately magnetizing an N pole and an S pole thereof in a circumferential direction may be used.

Here, the rotor case 210 may include a hub base 212 press-fitted into the upper end of the shaft 110 to thereby be fixed thereto and a magnet support part 214 extended from the hub base 212 in an outer diameter direction and bent downwardly in the axial direction to thereby support the magnet 220.

A fabricating method of the HDD motor 400 may be the same as a general fabricating method except that the adhesive resin composition 170 according to the embodiment of the present invention is applied to the inner surface of the base member 310 of the HDD motor or the outer surface of the sleeve 120 thereof to thereby adhere the base member 310 and the sleeve 120 to each other.

The following Table 1 is a table in which contents of each component and amounts of outgas of the HDD motor fabricated by applying the adhesive resin composition according to the embodiment of the present invention are compared with those of the HDD motor fabricated using the adhesive resin composition according to the related art.

More specifically, in the case of Inventive Examples 1 to 5, an adhesive resin composition was prepared to include 50 parts by weight of urethane methacrylate oligomer, 40 parts by weight of hydroxylalkyl methacrylate, 2 parts by weight of acrylic acid, and 2 parts by weight of organic hydroperoxide.

Particularly, the adhesive resin composition used in Inventive Examples 1 to 5 was prepared to include photo initiator in a numeral range of 2 to 5 parts by weight and copper soap in a numerical range of 0.5 to 3 parts by weight contained in a primer.

Meanwhile, an adhesive resin composition used in Comparative Examples 1 to 5 was prepared using the same method as the method used in Inventive Examples 1 to 5 except that it was prepared to include photo initiator in a numeral range of 1 to 2 parts by weight and copper soap in a numerical range of 0.5 or less of parts by weight contained in a primer.

Each component was analyzed by a gas chromatography-mass spectroscopy (GC-MS) analysis. Data on the analysis is shown in the following Table 1.

TABLE 1

| | Comparative Example (ng/part) | | | | | | Inventive Example (ng/part) | | | | | |
|---|---|---|---|---|---|---|---|---|---|---|---|---|
| Component | 1 | 2 | 3 | 4 | 5 | Average | 1 | 2 | 3 | 4 | 5 | Average |
| Acrylate | 2,531 | 1,670 | 1,675 | 92 | 1,347 | 1,453 | 416 | 279 | 292 | 343 | 285 | 323 |
| and | | | | | | | | | | | | |
| Methacrylate | | | | | | | | | | | | |
| Aliphatic | 35 | 75 | 54 | 8 | 11 | 37 | 41 | 76 | 61 | 127 | 95 | 80 |
| Hhydrocarbon | | | | | | | | | | | | |
| Aromatic | 97 | 122 | 186 | 94 | 119 | 124 | 166 | 190 | 179 | 221 | 158 | 183 |
| Hydrocarbon | | | | | | | | | | | | |
| Initiator | 272 | 319 | 446 | 227 | 392 | 331 | 423 | 544 | 406 | 544 | 391 | 462 |
| Antioxidant | 127 | 173 | 190 | 116 | 155 | 152 | 236 | 248 | 207 | 253 | 164 | 221 |
| Organic | — | — | 9 | — | — | 9 | 15 | — | — | — | — | 15 |
| Sulfide | | | | | | | | | | | | |
| Phenol | 59 | 82 | 96 | 40 | 68 | 69 | 69 | — | 100 | 22 | — | 64 |
| Phthalate | 25 | 57 | 44 | 26 | 64 | 43 | 48 | — | 45 | 66 | 30 | 47 |
| Alcohol | 157 | 211 | 264 | 105 | 144 | 175 | 23 | 401 | 221 | 350 | 197 | 238 |
| Other | 1,545 | 1,944 | 2,667 | 1,144 | 1,939 | 1,848 | 2,010 | 2,491 | 1,798 | 2,751 | 1,679 | 2,146 |
| components | | | | | | | | | | | | |
| Outgas | 6,377 | 7,190 | 7,618 | 3,122 | 5,854 | 6,032 | 5,302 | 6,350 | 5,190 | 6,777 | 4,688 | 5,661 |

It could be appreciated that in the case of Inventive Examples 1 to 5, acrylate and methacrylate were reduced to a level 4 to 5 times lower than those of Comparative Examples 1 to 5 and a total detected amount of outgas was reduced as compared to Comparative Examples 1 to 5.

Therefore, the HDD motor fabricated by applying the adhesive resin composition according to the embodiment of the present invention may be provided to reduce the generation of the outgas, whereby the improved reliable quality and the workability may be obtained.

As set forth above, according to the embodiments of the present invention, the HDD motor may be fabricated using the adhesive resin composition for a HDD motor prepared by controlling contents of an UV curable adhesive and a primer to reduce generation of outgas, whereby the improved reliable quality of the motor may be obtained.

In addition, a heat-curing time of the adhesive is reduced, whereby the workability may be improved.

While the present invention has been shown and described in connection with the embodiments, it will be apparent to those skilled in the art that modifications and variations can be made without departing from the spirit and scope of the invention as defined by the appended claims.

What is claimed is:

1. An adhesive resin composition for a hard disk drive (HDD) motor, the adhesive resin composition comprising:
45 to 55 parts by weight of an urethane methacrylate oligomer, 35 to 45 parts by weight of hydroxylalkyl methacrylate, 1 to 3 parts by weight of an acrylic acid, 1 to 2 parts by weight of organic hydroperoxide, and 2 to 5 parts by weight of a photo initiator.

2. The adhesive resin composition of claim 1, further comprising 1 to 5 parts by weight of primer.

3. The adhesive resin composition of claim 2, wherein the primer includes 95 parts by weight or more of acetone.

4. The adhesive resin composition of claim 2, wherein the primer includes 0.5 to 3 parts by weight of copper soap.

5. The adhesive resin composition of claim 2, wherein the primer includes 1 to 3 parts by weight of the copper soap.

6. The adhesive resin composition of claim 1, wherein the photo initiator has a content of 3 to 5 parts by weight contained in the adhesive resin composition.

7. A HDD motor comprising:
an adhesive resin composition including 45 to 55 parts by weight of an urethane methacrylate oligomer, 35 to 45 parts by weight of hydroxylalkyl methacrylate, 1 to 3 parts by weight of an acrylic acid, 1 to 2 parts by weight of organic hydroperoxide, and 2 to 5 parts by weight of a photo initiator.

8. The HDD motor of claim 7, wherein the adhesive resin composition further includes 1 to 5 parts by weight of primer.

9. The HDD motor of claim 8, wherein the primer includes 95 parts by weight or more of acetone.

10. The HDD motor of claim 8, wherein the primer includes 0.5 to 3 parts by weight of copper soap.

11. The HDD motor of claim 8, wherein the primer includes 1 to 3 parts by weight of copper soap.

12. The HDD motor of claim 7, wherein the adhesive resin composition includes 3 to 5 parts by weight of the photo initiator.

13. The HDD motor of claim 7, wherein the adhesive resin composition adheres abase member and a sleeve of the HDD motor to each other.
